(19) United States
(12) Patent Application Publication
(10) Pub. No.: US 2008/0022546 A1
(43) Pub. Date: Jan. 31, 2008

(54) Hairdryer hanging support device

(76) Inventor: Raymond Trudel, Baie-Comeau (CA)

Correspondence Address: Mr. Raymond Trudel, 9 rue Laval, Baie-Comeau, QC, G4Z 1P9, US

(21) Appl. No.: 11/491,831

(22) Filed: Jul. 25, 2006

(51) Int. Cl. F26B 19/00; B65H 75/48

(52) U.S. Cl. 34/90; 242/378.2

(57) ABSTRACT

A hanging device which handles the electric cord of the hairdryer while keeping that same hairdryer out of the way while leaving it within easy reach.

In order to do so, the invention comprises a system of pulleys and counterweight which act upon an electrical cable joined with the electrical cord of the hairdryer, and of which overhangs above a hairdresser's workstation.

### BACKGROUND OF THE INVENTION

1. Field of the Invention

This invention relates generally to supporting devices but more particularly to a device generally used for supporting lightweight hand-held tools such as hairdryers or other objects.

2. Brief Description of the Prior Art

A search of prior art records has unveiled the following patents:

1. U.S. Pat. No. 5,351,417 issued in 1994 to Rubin;
2. U.S. Pat. No. 4,417,703 issued in 1983 to Weinhold;

### 3. CA 2,756,945 issued in 1956 to Robboy;

4. U.S. Pat. No. 6,311,015 B1 issued in 2001 to Shih;
5. U.S. Pat. No. 5,357,052 issued in 1994 to Hakeem; and
6. U.S. Pat. No. 6,805,314 B2 issued in 2004 to Hopper.

Hair salons are busy places and sometimes elbow room is limited and while a hairdresser may be motivated to work on a client as quickly as possible, sometimes, the cord of the hairdryers gets in the way, not only does the cord get in the way but also, it is required that the hairdryer be set in a holster or other holding device generally set on or near the counter, sometimes the counter itself is the place where the hairdryer is set to rest in between uses.

### SUMMARY OF THE INVENTION

It is a main advantage of this invention to provide for a hanging device which handles the electric cord of the hairdryer while keeping that same hairdryer out of the way while leaving it within easy reach. In order to do so, the invention comprises a system of pulleys and counterweight which act upon an electrical cable joined with the electrical cord of the hairdryer, and of which overhangs above a hairdresser's workstation.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a side elevational view of a hairdryer hanging support device constructed in accordance and embodying the present invention and shown as being operational;

FIG. 2 is a side elevational view of the hairdryer hanging support device constructed in accordance and embodying the present invention and shown as being not operational;

FIG. 3 is a plan view of the hairdryer hanging device;

FIG. 4a is a plan view of the support disassembled of the hairdryer;

FIG. 4b is a plan view of the support assembled to the hairdryer.

### DETAILED DESCRIPTION OF THE PREFERRED EMBODIMENTS

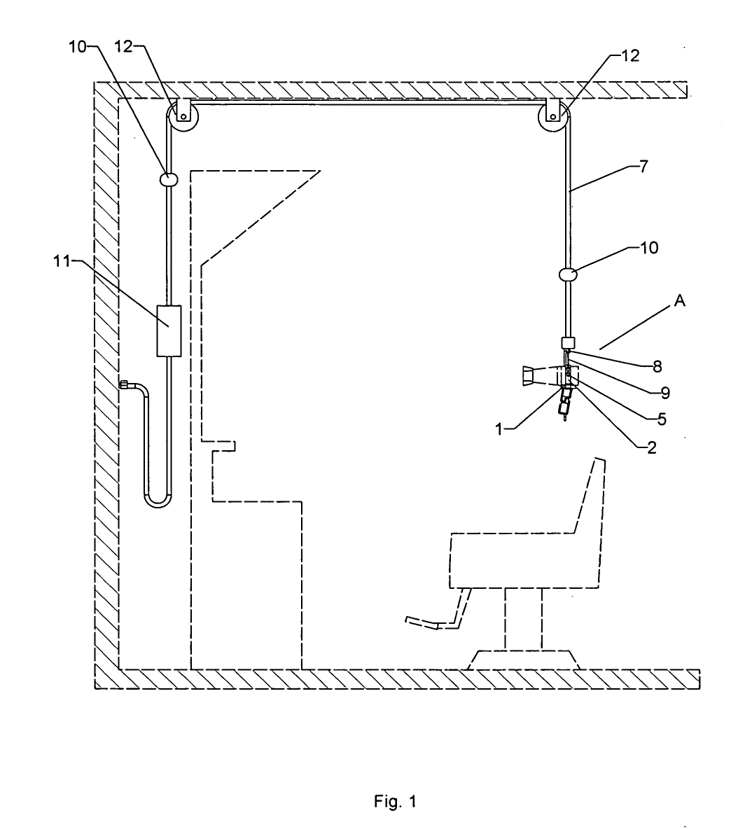

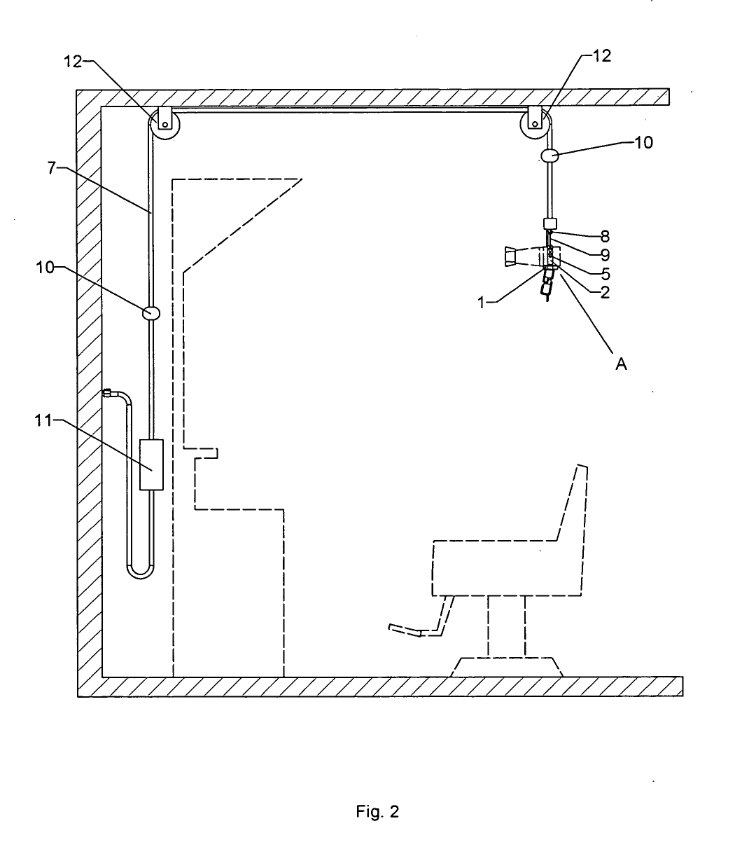

According to the preferred embodiment of the present invention, as depicted in FIGS. 1 to 2, a hairdryer hanging support device comprising a system of pulleys (12) secured to a ceiling and counterweight (11) which act upon an electrical cable (7) passing around the pulleys (12) and of which one end of the electrical cable (7) is joined with an electrical cord from the hairdryer, and which the other end of the electrical cable (7) is plugged in a standard wall outlet.

In use, a hairdresser will take the hairdryer in his hand and works on a customer's hair and in doing so will move the hairdryer so that the electrical cable (7) is tugged and released several times.

Located above the counterweight (11) is a stop means for blocking the electrical cable (7) at a predetermined distance as the hairdryer is pulled from said hanging device.

As the electrical cable (7) is released, the counterweight (11) will automatically pick up the slack of the electrical cable (7) and when the hairdresser has finished using the hairdryer, the counterweight (11) tugs on the electrical cable (7) until a stop means (10) is abutted against a pulley (12) for hanging up the hairdryer.

The electrical cable (7) overhangs above a hairdresser's workstation. An other embodiment of the invention is characterized in that the electrical cable (7) is channeled in a portable L-shaped tubular structure with adjustable foot (not shown).

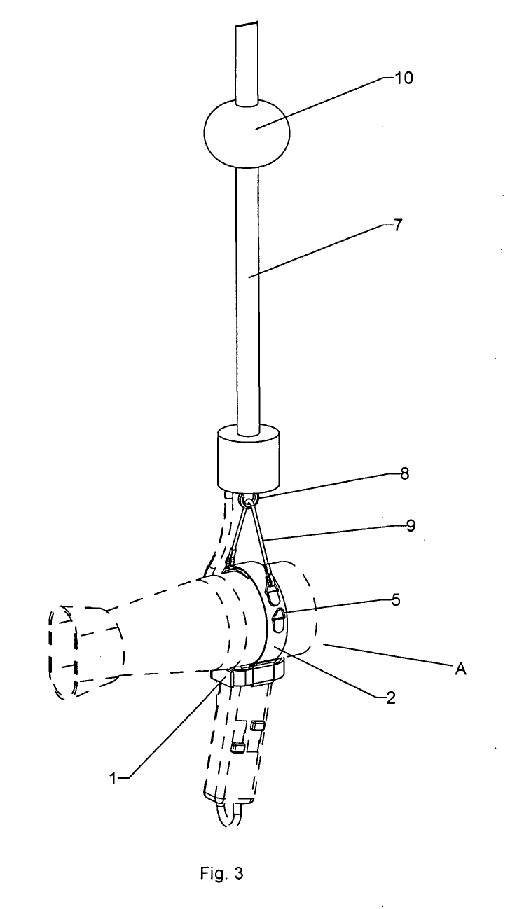

As depicted in FIG. 3, is located above the hairdryer a means for joining up the electrical cable (7) and the electrical cord from the hairdryer, of which is configured for receiving a retaining means like hook (8) to engage a cable (9) to be assembled therewith fastening means like eyelets (5) thereof two straps (2)(3) being formed as integral part of a support means (A) and of which the cable (9) allows the pivotal motion of the hairdryer.

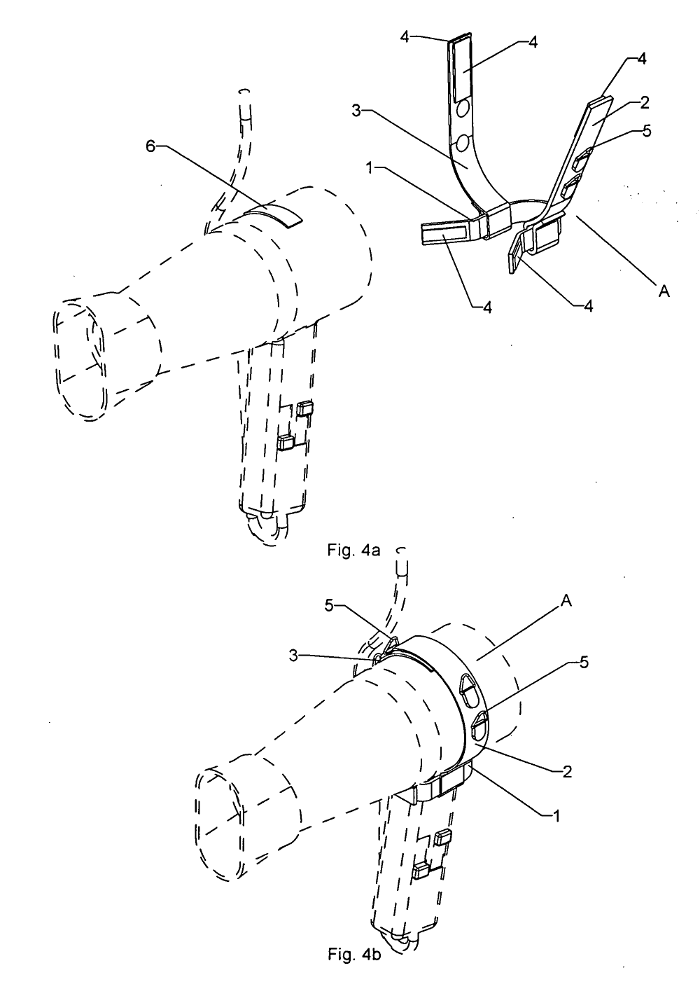

As depicted in FIGS. 4a and 4b, it is shown the support means (A) which is configured for supporting the hairdryer. The support (A) is composed of three straps (1)(2)(3) formed with bands of Velcro® (4), wherein a band of Velcro® (4) formed thereon a side of a first strap (2) is secured with a band of Velcro® (4) formed thereon a side of a second strap (3), and of which the second band of Velcro® (4) thereof the second strap (3) is secured with a band of Velcro® (6) thereupon the hairdryer. And further, a band of Velcro® (4) formed thereof a side at each end portion of a third strap (1) are secured therewith handle of the hairdryer.

Although only a single embodiment of the present invention has been described and illustrated, the present invention is not limited to the features of this embodiment, but includes all variations and modifications within the scope of claims.

I claim:

1. A hairdryer hanging support device comprising:
a system of pulleys secured to a ceiling and counterweight which act upon an electrical cable passing around the pulleys and of which one end of the electrical cable is joined with an electrical cord from a hairdryer, and which the other end of the electrical cable is plugged in a standard wall outlet;
a junction means for joining up said electrical cable and the electrical cord from the hairdryer, and of which is configured for receiving a retaining means like hook to engage a cable to be assembled therewith fastening means like eyelets thereof two straps being formed as integral part of a support means and of which the cable allows the pivotal motion of the hairdryer;
a stop means for blocking said electrical cable at a predetermined distance as the hairdryer is pulled from said hanging device;
a stop means for blocking said electrical cable as the counterweight tugs on the electrical cable for hanging up the hairdryer; and
wherein said electrical cable overhangs above a hairdresser's workstation.

2. The hairdryer support as claimed in claim 1 characterized in that said support has three straps formed with bands of Velcro®.

3. The hairdryer support as claimed in claim 2 characterized in that a band of Velcro® is formed thereon a side of a first strap which is secured with a band of Velcro® formed thereon a side of a second strap, and of which the second band of Velcro® formed thereof the second strap is secured with a band of Velcro® thereupon the hairdryer, and wherein a band of Velcro® formed thereof a side at each end portion of a third strap are secured therewith handle of the hairdryer.
